(19) United States
(12) Patent Application Publication
(10) Pub. No.: US 2006/0092929 A1
(43) Pub. Date: May 4, 2006

(54) Interwoven clock transmission lines and devices employing the same

(75) Inventor: Byung-kwan Chun, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/260,518

(22) Filed: Oct. 27, 2005

(30) Foreign Application Priority Data
Oct. 28, 2004 (KR) 2004-0086559

(51) Int. Cl. H04L 12/50

(52) U.S. Cl. 370/362

(57) ABSTRACT

An integrated circuit device includes a substrate and a side-by-side grouping of clock signal lines on the substrate. The side-by-side grouping includes at least three multi-segment clock signal lines that are substantially uniformly capacitively coupled to each other over a majority of their lengths. Electrical jumpers and conductive vias are used to link segments of each clock signal line together and achieve an interwoven relationship of the clock signal lines within the side-by-side grouping.

### CROSS-REFERENCE TO RELATED APPLICATION

This application claims priority under 35 U.S.C §119 from Korean Patent Application No. 10-2004-0086559, filed on Oct. 28, 2004, in the Korean Intellectual Property Office, the disclosure of which is hereby incorporated by reference herein in its entirety.

### BACKGROUND OF THE INVENTION

The present invention relates to transmission lines, and more particularly, to clock transmission lines and devices employing the same.

A variety of high-speed memory devices have been recently developed and manufactured. In particular, DDR (double data rate) memory, in which data may be input and/or output at every transition of a system clock, and QDR (quad data rate) memory, in which data may be input and/or output at up to four times per cycle of the system clock, have been developed.

One feature of existing high-speed memory devices, such as those described above, is that data input from or output to an external device may be processed based on synchronization with an internal clock. The internal clock may be generated based on a system clock input from an external device. To generate the internal clock, memory devices typically include a delay locked loop (DLL) or a phase locked loop (PLL).

FIG. 1 is a block diagram of a semiconductor device including a conventional multi-phase clock transmission line output from a PLL 110.

Referring now to FIG. 1, the PLL 110 may receive a reference clock CLK_R and may generate a plurality of clock signals with different phases. The generated clocks may be transmitted to a plurality of ports PORT1, PORT2, PORT3, and PORT4 for input/output interfacing with an external device, via the respective clock transmission lines.

Each of the ports PORT1, PORT2, PORT3, and PORT4 may include an input buffer, an output buffer, and the like, which may be synchronized with the clock signals transmitted via the clock transmission lines. The width the clock transmission lines that transmit clock signals to the ports PORT1 and PORT4 (which may be further from the PLL 110), may be greater than the width the clock transmission lines that transmit clock signals to the ports PORT2 and PORT3 (which may be closer to the PLL 110). Thus, RC delay time for clock signal transmission to each of the ports PORT1, PORT2, PORT3, and PORT4 may be equalized.

As an alternative to increasing the width of the clock transmission lines, the distance of the ports PORT2 and PORT3 from the PLL 110 can be adjusted to be identical and/or similar to the distance of the ports PORT1 and PORT4 from the PLL 110 to equalize RC delay.

FIG. 2 is a diagram illustrating a conventional multi-phase clock transmission line 200. Referring now to FIG. 2, the multi-phase clock transmission line 200 may include two shielding lines S1 and S2 and a plurality of clock signal transmission lines L1, L2, L3 and L4 between the shielding lines S1 and S2. The plurality of transmission lines L1, L2, L3, and L4 may (respectively) sequentially transmit a clock signal CLK0 having a phase of 0 degrees, a clock signal CLK90 having a phase of 90 degrees, a clock signal CLK180 having a phase of 180 degrees, and a clock signal CLK270 having a phase of 270 degrees, which are output from the PLL 110.

FIG. 3 is a timing diagram illustrating clock signal transmission on a conventional multi-phase clock transmission line, such as the multi-phase clock transmission line of FIG. 2.

FIG. 3 illustrates a clock with a period of 1.6 ns. More specifically, FIG. 3 illustrates the relative timing of clock signals transmitted from an output terminal A of the PLL 110 shown in FIG. 1, as well as the relative timing of the clock signals received at a port B.

The phase difference between the adjacent clock signals transmitted via each transmission line L1, L2, L3, and L4 from terminal A is about 90 degrees, and the temporal difference between the clocks is about 400 ps.

As shown in FIG. 3, the phase difference between clock signals CLK90 and CLK180 transmitted on the transmission lines L2 and L3 may be maintained between transmission from output terminal A of the PLL 110 and reception at port terminal B. However, the relative phases of the clocks CLK0 and CLK270 transmitted on the transmission lines L1 and L4 may be altered between transmission from output terminal A of the PLL 110 and reception at port terminal B, for example, due to coupling effects from transmission lines L2 and L3, respectively.

In particular, coupling effects on clock signal CLK 90 may be offset due to coupling interaction between clock signals CLK0 and CLK180 on both sides of the clock CLK90. In other words, the coupling effects on clock CLK90 due to clock CLK10 may be canceled by the coupling effects due to clock CLK180. Thus, the relative phase of clock CLK90 at the output terminal A of the PLL 110 may be maintained at the port terminal B.

Similarly, coupling effects on clock signal CLK270 may be offset due to coupling interaction between clocks CLK90 and CLK270 on both sides of clock CLK180. As such, the relative phase of clock CLK180 may be maintained between transmission from the output terminal A of the PLL 110 and reception at the port terminal B.

However, the clock signal CLK0 is transmitted via the transmission line L1, which is between the shielding line S1 and the clock CLK90 transmitted via the transmission line L2. As such, clock CLK0 may be affected by coupling effects from CLK90. Accordingly, as compared with the phase of the clock CLK0 at the output terminal A of the PLL 110, the phase of the clock CLK0 at the port terminal B may be altered due to coupling effects from clock CLK90.

Therefore, at the port terminal B, the time difference between the clock signals CLK0 and CLK90 may be about 300 ps, i.e., about 100 ps less than the 400 ps time difference at the output terminal A.

Similarly, as compared with the phase of clock CLK270 at the output terminal A of the PLL 110, the phase of clock CLK270 transmitted via the transmission line L4 at the port terminal B may be altered due to coupling effects from clock CLK180.

Thus, the time difference between the clock signals CLK180 and CLK270 at the port terminal B may be about 300 ps, i.e., about 100 ps less than the 400 ps time difference at the output terminal A of the PLL 110. Accordingly, the time difference between clock signals CLK270 and CLK0 may become about 500 ps, i.e., about 100 ps greater than the relative time difference at the output terminal A.

As described above, the relative phase difference between clock signals input to the input/output buffer circuit installed at each of the ports PORT1, PORT2, PORT3, and PORT4 may be different than the phase difference between the clock signals transmitted from the output terminal of the PLL 110, which may affect the rate of data input to and/or output from a high-speed semiconductor device. Accordingly, high-speed operation of the semiconductor device may be degraded.

### SUMMARY OF THE INVENTION

Some embodiments of the present invention may provide a multi-phase clock transmission line capable of reducing phase distortion of transmitted clocks.

Some embodiments of the present invention may also provide a semiconductor device including a multi-phase clock transmission line capable of preventing phase distortion of transmitted clocks.

According to some embodiments of the present invention, a clock transmission line may include a first transmission line transmitting a first clock with a first phase, a second transmission line transmitting a second clock with a second phase, a third transmission line transmitting a third clock with a third phase, a fourth transmission line transmitting a fourth clock with a fourth phase, a first shielding line of which a length adjacent to the first transmission line and a length adjacent to the second transmission line are equal, and a second shielding line of which a length adjacent to the third transmission line and a length adjacent to the fourth transmission line are equal.

According other embodiments of the present invention, a clock transmission line may include a plurality of transmission lines which are interposed between a first shielding line and a second shielding line, wherein the plurality of transmission lines are disposed in the order of a first transmission line, a second transmission line, a third transmission line and a fourth transmission line in a first half of a predetermined transmission distance and disposed in the order of the second, the fourth, the first, and the third transmission lines in the remaining half of the transmission distance.

According to still other embodiments of the present invention, a semiconductor device may include a phase locked loop generating a plurality of clocks with different phases in response to a reference clock, a port for input/output interfacing with an external device, and a clock transmission line transmitting the plurality of clocks with different phases. The clock transmission line may include a first transmission line transmitting a first clock with a first phase, a second transmission line transmitting a second clock with a second phase, a third transmission line transmitting a third clock with a third phase, a fourth transmission line transmitting a fourth clock with a fourth phase, a first shielding line of which a length adjacent to the first transmission line and a length adjacent to the second transmission line are equal, and a second shielding line of which a length adjacent to the third transmission line and a length adjacent to the fourth transmission line are equal.

According to some embodiments of the present invention, an integrated circuit device may include a substrate and a side-by-side grouping of clock signal lines on the substrate. The side-by-side grouping may include at least three multi-segment clock signal lines that are substantially uniformly capacitively coupled to each other over a majority of their lengths and use electrical jumpers and conductive vias to link segments of each clock signal line together and achieve an interwoven relationship of the clock signal lines within the side-by-side grouping. As such, segments of the clock signal lines may change relative locations without electrical interruption.

In some embodiments, a degree of capacitive coupling between some segments of the at least three clock signal lines may be non-uniform.

In other embodiments, a degree of capacitive coupling between a first of the at least three clock signals lines and a second of the at least three clock signal lines may equal a degree of capacitive coupling between the second of the at least three clock signals lines and a third of the at least three clock signal lines, and may also equal a degree of capacitive coupling between the third of the at least three clock signals lines and the first of the at least three clock signal lines.

In some embodiments, the integrated circuit device may further include first and second shielding lines. The side-by-side grouping of clock signal lines may be positioned between the first and second shielding lines. The first and second shielding lines may be connected to a source voltage or a ground voltage.

In other embodiments, the at least three clock signal lines may respectively include a first segment immediately adjacent to one of the first and second shielding lines, a second segment immediately adjacent to one of the at least three clock signal lines at opposite sides thereof, and a transitional segment therebetween crossing over at least one of the at least three clock signal lines without electrical interruption. The first and second segments of the at least three clock signal lines may extend parallel to each other on a same metallization layer of the substrate, and the first segments of each of the at least three clock signal lines may be approximately equal in length.

In some embodiments, the at least three clock signal lines may include a first clock signal line configured to transmit a first clock signal, a second clock signal line configured to transmit a second clock signal, a third clock signal line configured to transmit a third clock signal, and a fourth clock signal line configured to transmit a fourth clock signal. The transitional segment of the first clock signal line may cross over the second and fourth clock signal lines, the transitional segment of the second clock signal line may cross over the first clock signal line, the transitional segment of the third clock signal line may cross over the fourth clock signal line, and the transitional segment of the fourth clock signal line may cross over the first and third clock signal lines.

In other embodiments, the first clock signal may have a phase of 0 degrees, the second clock signal may have a phase of 90 degrees, the third clock signal may have a phase of 180 degrees, and the fourth clock signal may have a phase of 270 degrees.

In some embodiments, the integrated circuit device may further include a phase locked loop configured to generate at least three clock signals having different phases responsive to a reference clock, and at least one port having an input buffer and an output buffer. The at least three clock signal lines may connect the phase locked loop with the at least one port and may transmit the at least three clock signals therebetween.

According to further embodiments of the present invention, a transmission line may include a side-by-side grouping of clock signal lines on a substrate. The side-by-side grouping may include at least three multi-segment clock signal lines that are substantially uniformly capacitively coupled to each other over a majority of their lengths and use electrical jumpers and conductive vias to link segments of each clock signal line together and achieve an interwoven relationship of the clock signal lines within the side-by-side grouping.

According to still further embodiments of the present invention, a clock transmission line may include first through fourth transmission lines and first and second shielding lines surrounding the first through the fourth transmission lines. A length of the first and second transmission lines immediately adjacent to the first shielding line may be equal to a length of the third and fourth transmission lines immediately adjacent to the second shielding line.

### BRIEF DESCRIPTION OF THE DRAWINGS

FIG. 1 is a block diagram illustrating a semiconductor device including a conventional multi-phase clock transmission line output from a phase locked loop (PLL);

FIG. 2 is a diagram illustrating a conventional multi-phase clock transmission line;

FIG. 3 is a timing diagram illustrating clock signal transmission via the conventional multi-phase clock transmission line shown in FIG. 1;

FIGS. 4A and 4B are diagrams illustrating multi-phase clock transmission lines according to some embodiments of the present invention; and

FIG. 5 is a timing diagram illustrating clock signal transmission using a multi-phase clock transmission line according to some embodiments of the present invention.

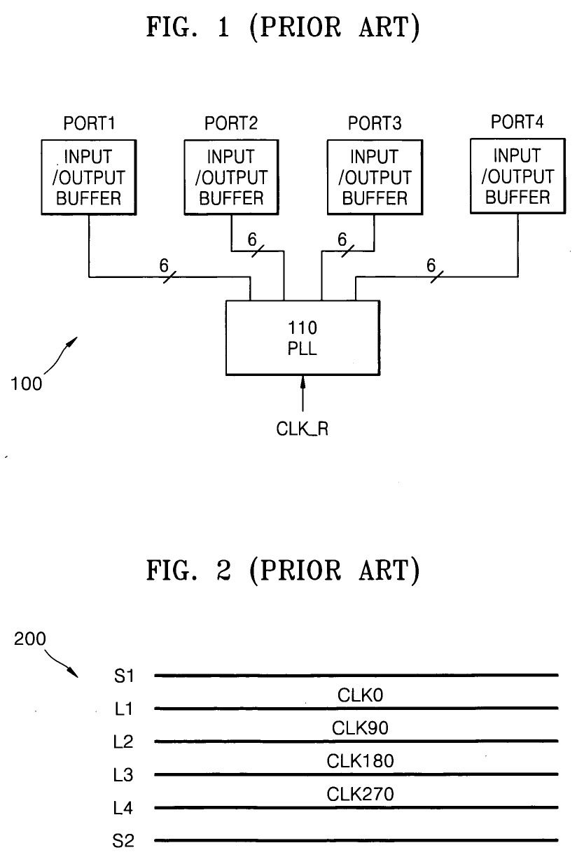

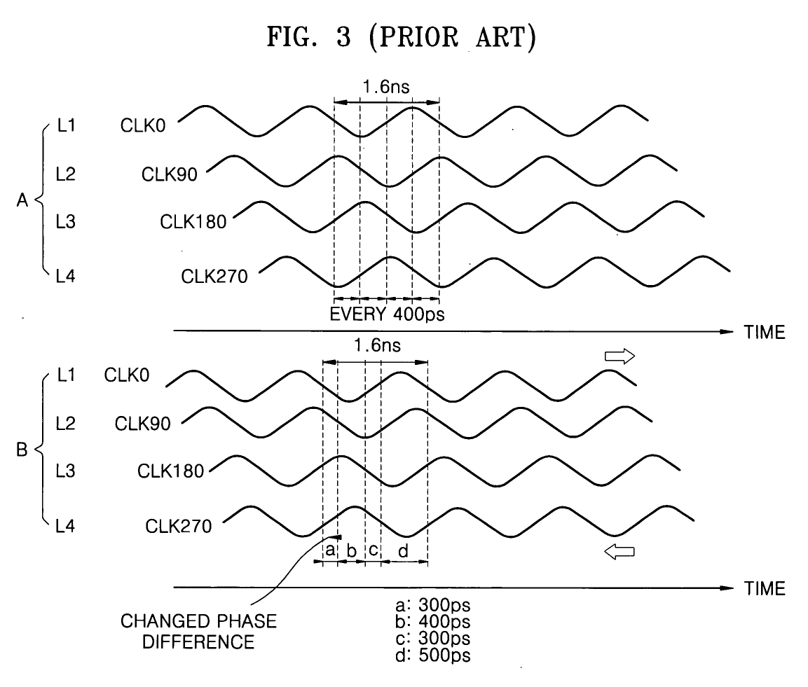

### DETAILED DESCRIPTION OF EMBODIMENTS OF THE INVENTION

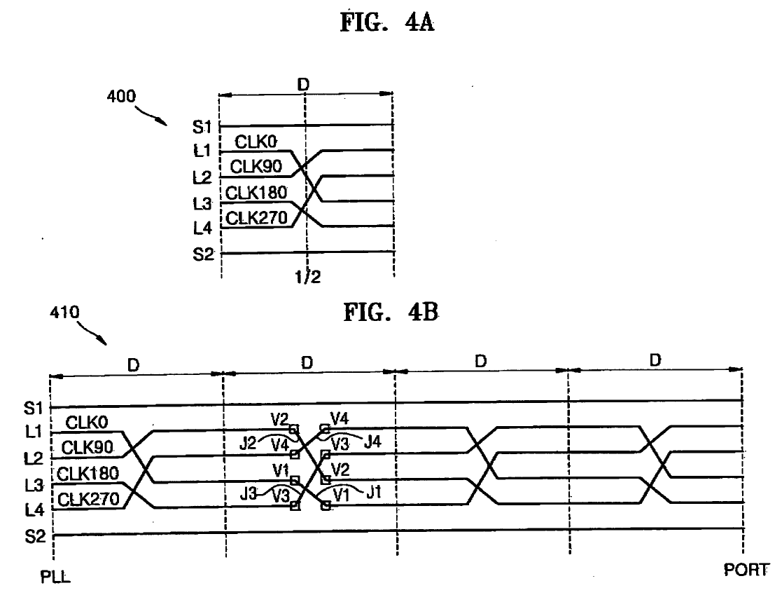

FIGS. 4A and 4B are diagrams illustrating multi-phase clock transmission lines according to some embodiments of the present invention.

More specifically, FIG. 4A illustrates a multi-phase clock transmission line 400 including multiple segments that are “twisted” at predetermined intervals. In other words, segments of the clock signal lines cross over one another in an interwoven manner such that their relative locations are varied along the length of the transmission line 400. FIG. 4B illustrates an extended twisted multi-phase clock transmission line 410 through which a multi-phase clock is transmitted from a phase locked loop to an input/output port.

Referring now to FIG. 4A, the multi-phase clock transmission line 400 includes a plurality of multi-segment clock signal transmission lines L1, L2, L3, and L4 twisted with one another and positioned in a side-by-side grouping between a first shielding line S1 and a second shielding line S2. The first and second shielding lines S1 and S2 may be connected to voltages, such as a source voltage or a ground voltage.

As such, the clock transmission line 400 includes the first shielding line S1, the second shielding line S2, and the clock signal lines L1, L2, L3, and L4 between the first and second shielding lines S1 and S2. The clock signal lines L1, L2, L3, and L4 respectively transmit multi-phase clock signals CLK0, CLK90, CLK180, CLK270.

As shown in FIG. 4A, the clock signal lines L1, L2, L3, and L4 are arranged between the first shielding line S1 and the second shielding line S2 in the order of the first clock signal line L1, the second clock signal line L2, the third clock signal line L3, and the fourth clock signal line L4 for a first half of a transmission distance D. For the remaining half of the transmission distance D, the clock signal lines are arranged in the order of the second clock signal line L2, the fourth clock signal line L4, the first clock signal line L1, and the third clock signal line L3.

More particularly, the first clock signal line L1, which transmits clock CLK0 with a phase of 0 degrees, is adjacent to the first shielding line S1 for the first half of the transmission distance D. The first clock signal line L1 crosses the second clock signal line L2, which transmits clock CLK90 with a phase of 90 degrees, and crosses the fourth clock signal line L4, which transmits a clock CLK270 with a phase of 270 degrees, at approximately the half-way point of the transmission distance D. The clock signal lines may “cross” on different metallization levels of the substrate, for example, using conductive vias and electrical jumpers to link the segments of each line.

The second clock signal line L2 is positioned between the first clock signal line L1 and the third clock signal line L3, which transmits clock CLK180 with a phase of 180 degrees, for the first half of the transmission distance D. The second clock signal line L2 crosses the first clock signal line L1 at approximately the half-way point of the distance D, and is adjacent to the first shielding line S1 for the remaining half of the transmission distance D.

The third clock signal line L3 is positioned between the second clock signal line L2 and the fourth clock signal line L4 for the first half of the distance D. The third clock signal line L3 crosses the fourth clock signal line L4 at approximately the half-way point of the transmission distance D, and is adjacent to the second shielding line S2 for the remaining half of the transmission distance D.

The fourth clock signal line L4 is positioned between the third clock signal line L3 and the second shielding line S2 for the first half of the distance D. The fourth clock signal line L4 crosses the third clock signal line L3 and the first clock signal line L1 at approximately the half-way point of the transmission distance D.

Accordingly, when a plurality of side-by-side clock signal lines L1, L2, L3, and L4 are arranged in an interwoven manner as described above, the relative positions of each line can be altered so that each of the clock signal lines can be immediately adjacent to one of the shielding lines S1 and S2 for approximately the same distance. In other words, the length of the segment of first clock signal line L1 that is immediately adjacent to the first shielding line S1 for the first half of the distance D is approximately equal to the length of the segment of the second clock signal line L2 that is immediately adjacent to the first shielding line S1 for the remaining half of the distance D.

Likewise, the length of the segment of the third clock signal line L3 that is immediately adjacent to the second shielding line S2 for the second half of the distance D is approximately equal to the length of the segment of the fourth clock signal line L4 that is immediately adjacent to the second shielding line S2 for the first half of the distance D. As such, the coupling effects between the clock signal lines L1-L4 may be approximately equal. In other words, the clock signal lines L1-L4 may be substantially uniformly capacitively coupled to each other along a majority of their respective lengths. Thus, phase shift during transmission of the clock signals CLK0-CLK270 can be equally offset.

FIG. 4B is a diagram illustrating a multi-phase clock transmission line 410 connected between a PLL (not shown) and a port (not shown). Referring now to FIG. 4B, the multi-phase clock transmission line 410 is formed by repeating the clock transmission line 400 of FIG. 4A once every distance of D. More particularly, the multi-phase clock transmission line 410 includes multi-segment clock signal lines L1, L2, L3, and L4. The segments of each clock signal line L1-L4 are respectively connected by transitional segments, also referred to as electrical jumpers J1-J4, and pairs of conductive vias V1-V4. The jumpers J1-J4 may cross on different metallization levels of the substrate, linking substantially parallel segments of each clock signal line to achieve an interwoven relationship between the clock signal lines L1-L4.

Still referring to FIG. 4B, the lengths of the segments of the clock signal lines L1, L2, L3, and L4 that are immediately adjacent to the shielding line S1 and S2 are approximately equal, as shown in FIG. 4A. Thus, during transmission of the multi-phase clock from the PLL to the port, the length of the segments of each clock signal line L1, L2, L3, and L4 that are immediately adjacent to the shielding lines S1 and S2 totals approximately 2D, and the length of the segments of each clock signal line L1-L4 that are positioned between other clock signal lines L1-L4 totals approximately 2D.

Of course, to equalize the RC delay time of each clock signal line, the widths of clock signal lines that transmit clock signals to ports which are further from the PLL may be greater than the widths of clock signal lines that transmit clock signals to ports which are closer to the PLL.

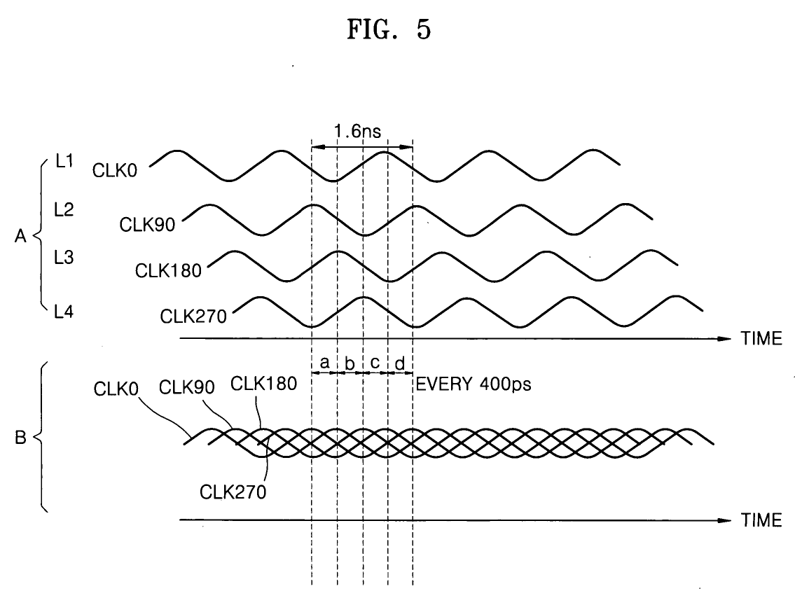

FIG. 5 is a timing diagram illustrating clock signals transmitted using a clock transmission line according to some embodiment of the present invention.

Referring now to FIG. 5, the phases of clock signals A (output from the PLL) and clock signals B (received at the port) are unchanged. More particularly, the period of the clock signals output from the PLL is set to 1.6 ns. The phase difference between each clock signal CLK0, CLK90, CLK180, and CLK270 respectively transmitted through the clock signal lines L1, L2, L3, and L4 is 90 degrees. The clock signals CLK0, CLK90, CLK180, and CLK270 are transmitted to an input/output port, for example, to interface with an external device.

The phase differences between the clock signals CLK0, CLK90, CLK180, and CLK270 that are output from the PLL (shown in A of FIG. 5) are preserved when received at the input/output port terminal (shown in B of FIG. 5).

Accordingly, the time difference between the clock signals CLK0, CLK90, CLK180, and CLK270 transmitted through the clock signal lines L1, L2, L3, and L4, (i.e., 400 ps), is also preserved.

Thus, in embodiments of the present invention as described above, clock signals with a phase difference of 90 degrees are sequentially transmitted through the plurality of side-by-side clock signal transmission lines L1, L2, L3, and L4 between the first shielding line S1 and the second shielding line S2. The clock signal lines L1, L2, L3, and L4 are arranged in an interwoven manner between the first shielding line S1 and the second shielding line S2, such that each clock signal line is immediately adjacent a shielding line for about the same distance, and such that each clock signal line is positioned between other clock signal lines for about the same distance. Accordingly, a uniform degree of capacitive coupling between the clock signal lines may be provided by the interwoven relationship of the clock signal lines within the side-by-side grouping.

A semiconductor device according to further embodiments of the present invention includes a phase locked loop (PLL) that generates a plurality of clock signals having different phases based on a reference clock, at least one input/output port for interfacing with an external device, and a multi-phase clock transmission line which transmits the plurality of clocks to the port.

The clock transmission line includes a side-by-side grouping of a first multi-segment clock signal line for transmitting a first clock with a first phase, a second multi-segment clock signal line for transmitting a second clock with a second phase, a third multi-segment clock signal line for transmitting a third clock with a third phase, and a fourth multi-segment clock signal line for transmitting a fourth clock with a fourth phase. The clock transmission line also includes a first shielding line and a second shielding line. The length of the segments of the first clock signal line that are immediately adjacent to the first shielding line is approximately the same as the length of the segments of the second clock signal line that are immediately adjacent to the first shielding line. Likewise, the length of the segments of the third clock signal line that are immediately adjacent to the second shielding line is approximately the same as the length of the segments of the fourth clock signal line that are immediately adjacent to the second shielding line. Electrical jumpers and conductive vias may link the segments of each line in an interwoven manner.

The configuration of the multi-phase clock transmission line of the semiconductor device may be similar to that of the multi-phase clock transmission lines described above with reference to FIGS. 4A and 4B. As such, further description thereof will be omitted.

Thus, according to some embodiments of the present invention, a multi-segment clock transmission line configured to transmit a multi-phase clock can maintain a relatively exact phase difference between transmitted signals due to substantially uniform capacitive coupling between the individual clock signal lines arranged in an interwoven manner. Accordingly, a semiconductor device employing such a clock transmission line may input and output data for high-speed operations in a more stable manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An integrated circuit device, comprising:
a substrate; and
a side-by-side grouping of clock signal lines on the substrate, the side-by-side grouping including at least three multi-segment clock signal lines that are substantially uniformly capacitively coupled to each other over a majority of their lengths and use electrical jumpers and conductive vias to link segments of each clock signal line together and achieve an interwoven relationship of the clock signal lines within the side-by-side grouping.

2. The device of claim 1, wherein a degree of capacitive coupling between a first of the at least three clock signals lines and a second of the at least three clock signal lines equals a degree of capacitive coupling between the second of the at least three clock signals lines and a third of the at least three clock signal lines and equals a degree of capacitive coupling between the third of the at least three clock signals lines and the first of the at least three clock signal lines.

3. The device of claim 1, further comprising:
first and second shielding lines,
wherein the side-by-side grouping of clock signal lines is positioned between the first and second shielding lines.

4. The transmission line of claim 3, wherein the first and second shielding lines are connected to a source voltage or a ground voltage.

5. The device of claim 3, wherein the at least three clock signal lines respectively include a first segment immediately adjacent to one of the first and second shielding lines, a second segment immediately adjacent to one of the at least three clock signal lines at opposite sides thereof, and a transitional segment therebetween crossing over at least one of the at least three clock signal lines without electrical interruption.

6. The device of claim 5, wherein the first and second segments of the at least three clock signal lines extend substantially parallel to each other on a same metallization layer of the substrate.

7. The device of claim 5, wherein the first segments of each of the at least three clock signal lines are approximately equal in length.

8. The device of claim 5, wherein the at least three clock signal lines comprises:
a first clock signal line configured to transmit a first clock signal;
a second clock signal line configured to transmit a second clock signal;
a third clock signal line configured to transmit a third clock signal; and
a fourth clock signal line configured to transmit a fourth clock signal,
wherein the transitional segment of the first clock signal line crosses over the second and fourth clock signal lines, wherein the transitional segment of the second clock signal line crosses over the first clock signal line, wherein the transitional segment of the third clock signal line crosses over the fourth clock signal line, and wherein the transitional segment of the fourth clock signal line crosses over the first and third clock signal lines.

9. The device of claim 8, wherein the first clock signal has a phase of 0 degrees, wherein the second clock signal has a phase of 90 degrees, wherein the third clock signal has a phase of 180 degrees, and wherein the fourth clock signal has a phase of 270 degrees.

10. The device of claim 1, further comprising:
a phase locked loop configured to generate at least three clock signals having different phases responsive to a reference clock; and
at least one port having an input buffer and an output buffer,
wherein the at least three clock signal lines connect the phase locked loop with the at least one port and transmit the at least three clock signals therebetween.

11. A transmission line, comprising:
a side-by-side grouping of clock signal lines on a substrate, the side-by-side grouping including at least three multi-segment clock signal lines that are substantially uniformly capacitively coupled to each other over a majority of their lengths and use electrical jumpers and conductive vias to link segments of each clock signal line together and achieve an interwoven relationship of the clock signal lines within the side-by-side grouping.

12. The transmission line of claim 11, wherein a degree of capacitive coupling between a first of the at least three clock signals lines and a second of the at least three clock signal lines equals a degree of capacitive coupling between the second of the at least three clock signals lines and a third of the at least three clock signal lines and equals a degree of capacitive coupling between the third of the at least three clock signals lines and the first of the at least three clock signal lines.

13. The transmission line of claim 11, further comprising:
first and second shielding lines,
wherein the side-by-side grouping of clock signal lines is positioned between the first and second shielding lines.

14. The transmission line of claim 13, wherein the first and second shielding lines are connected to a source voltage or a ground voltage.

15. The transmission line of claim 13, wherein the at least three clock signal lines respectively include a first segment immediately adjacent to one of the first and second shielding lines, a second segment immediately adjacent to one of the at least three clock signal lines at opposite sides thereof, and a transitional segment therebetween crossing over at least one of the at least three clock signal lines without electrical interruption.

16. The transmission line of claim 15, wherein the first and second segments of the at least three clock signal lines extend substantially parallel to each other on a same metallization layer of the substrate.

17. The transmission line of claim 15, wherein the first segments of each of the at least three clock signal lines are approximately equal in length.

18. The transmission line of claim 15, wherein the at least three clock signal lines comprises:
a first clock signal line configured to transmit a first clock signal;
a second clock signal line configured to transmit a second clock signal;
a third clock signal line configured to transmit a third clock signal; and
a fourth clock signal line configured to transmit a fourth clock signal,
wherein the transitional segment of the first clock signal line crosses over the second and fourth clock signal lines, wherein the transitional segment of the second clock signal line crosses over the first clock signal line, wherein the transitional segment of the third clock signal line crosses over the fourth clock signal line, and wherein the transitional segment of the fourth clock signal line crosses over the first and third clock signal lines.

19. The transmission line of claim 18, wherein the first clock signal has a phase of 0 degrees, wherein the second clock signal has a phase of 90 degrees, wherein the third clock signal has a phase of 180 degrees, and wherein the fourth clock signal has a phase of 270 degrees.

20. A clock transmission line comprising:
first through fourth transmission lines; and
first and second shielding lines surrounding the first through the fourth transmission lines,
wherein a length of the first and second transmission lines immediately adjacent to the first shielding line is equal to a length of the third and fourth transmission lines immediately adjacent to the second shielding line.

21-34. (canceled)
